(19) United States
(12) Patent Application Publication
(10) Pub. No.: US 2008/0045417 A1
(43) Pub. Date: Feb. 21, 2008

(54) Oligonucleotide Microarray

(76) Inventors: Jan Weiler, Lorrach-Haagen (DE); Jonathan Hall, Dornach (GB); Christoph Wanke, Biel-Benken (CH); Jorg Bernd Lange, Freiburg i. Br. (DE); Witold Filipowicz, Riehen (CH); Fabrice Kolb, Mulhouse (FR)

Correspondence Address: NOVARTIS INSTITUTES FOR BIOMEDICAL RESEARCH, INC., 400 TECHNOLOGY SQUARE, CAMBRIDGE, MA, 02139, US

(21) Appl. No.: 10/574,305

(22) PCT Filed: Oct. 13, 2004
(86) PCT No.: PCT/EP04/11511

§ 371 Date: Apr. 23, 2007

Related U.S. Application Data
(60) Provisional application No. 60/510,884, filed on Oct. 14, 2003.

(51) Int. Cl. C40B 30/04; C40B 40/08

(52) U.S. Cl. 506/9; 506/17

(57) ABSTRACT

The present invention relates to oligonucleotide microarrays comprising short chemically modified RNA oligonucleotides and uses of such microarrays in genomics applications. More specifically, the invention provides an oligonucleotide array comprising a surface and a plurality of oligonucleotide, wherein at least one oligonucleotide has at least one modified sugar moiety at the 2'OH position. The microarrays of the invention are more specifically useful to detect small RNAs.

This application is the National Stage of Application No. PCT/EP2004/011511, filed on Oct. 13, 2004, which claims benefit under 35 U.S.C. § 119(e) of U.S. Provisional Application No. 60/510,884, filed Oct. 13, 2003. The contents of both are incorporated herein by reference in their entirety.

### FIELD OF THE INVENTION

The present invention relates to oligonucleotide microarrays comprising short chemically modified RNA oligonucleotides and uses of such microarrays in genomics applications.

### BACKGROUND OF THE INVENTION

Microarrays of biopolymers have become valuable tools in biomedical research. Microarray technology has advanced to such a point that microarrays are cost-effective and can be provided to researchers with the desired flexibility and quality assurance (Barrett J Carl; Kawasaki Ernest S Microarrays: the use of oligonucleotides and cDNA for the analysis of gene expression. Drug Discovery Today, 2003, 8, 134-41). There are many microarray platforms with various types of biopolymer arrays available, such as, for instance, protein or peptide arrays including antibodies or enzyme arrays. Other available micorarray platforms use DNA arrays, of which there are several types differing by the form of the surface-bound oligonucleotide probes: examples include cDNA arrays using long polynucleotides which are usually spotted onto a solid support surface, DNA oligonucleotide arrays composed of long (e.g. 40-80 nucleotides) oligonucleotides either spotted onto array surfaces or attached through terminal linkages, and short (e.g. 25-nucleotide (nt) oligonucleotides synthesized in situ (e.g. Affymetrix). The power of DNA microarrays as experimental tools relies on the specific molecular recognition via complementary base pairing, which makes them highly useful for simultaneous analysis of gene expression in high-throughput. In the post-genomic era, microarrays have become an important tool for the development of many hybridization-based assays, such as expression profiling, single nucleotide polymorphism (SNP) detection, DNA sequencing and large-scale genotype analysis.

Recently, it has been discovered that eukaryotic cells contain a large number of short RNAs from about 18 to about 25 nucleotides. Such short RNAs act for instance as effectors of RNA interference (RNAi) or as regulators of gene expression at the posttranscriptional level. RNAi is an evolutionarily conserved process that is based on converting long double-stranded (ds) RNA to 20 to 23 nucleotide short-interfering dsRNAs (siRNAs), which silence genes through degradation of the target mRNA. Other short RNAs include microRNAs (miRNAs) and small temporal RNAs (stRNAs), a subset of a larger group of miRNAs, which are processed from endogenously encoded hairpin precursors (70 to 100 nucleotides or longer) as single-stranded 18 to 25 nucleotide RNAs and appear to function via translational repression through the base-pairing to the 3′-UTRs of the target mRNAs (Lau N C; Lim L P; Weinstein E G; Bartel D P; Science (2001), 294, 858-62).

Although about 200 different miRNAs have been identified in plants, C. elegans, Drosophila and mammals so far, only the stRNAs lin-4 and let-7 have been well documented to regulate the timing of gene expression at the translational level during larvae development in C. elegans. In vertebrates, expression of many miRNAs have important developmental or tissue-specific patterns but at present the function of only very few is established. The increasing number and diversity of miRNAs (Lim, Lee P.; Glasner, Margaret E.; Yekta, Soraya; Burge, Christopher B.; Bartel, David P. Vertebrate microRNA genes. Science 2003, 299, 1540) argues that miRNAs play an important role in a variety of pathways other than the developmental timing. This is supported by the findings that in Drosophila miRNAs are involved in regulation of cell death and proliferation, and are required for normal fat metabolism (Xu et al., 2003; see Current Biol. 13, 790-795 (2003); Brennecke et al., 2003 (Cell 113, 25-36 (2003). Moreover, miRNAs seem to be associated with human diseases. Recent studies carried out in Drosophila have linked the RNAi/miRNA pathway with the protein dFMR1, a homolog of the human protein FMR1 affected in the Fragile X syndrome, the most common hereditary form of mental retardation (Caudy, Amy A.; Myers, Mike; Hannon, Gregory J.; Hammond, Scott M. Fragile X-related protein and VIG associate with the RNA interference machinery. Genes & Development 2002, 16, 2491-2496). In addition, two miRNAs located on chromosome 13q14 have been found to be deleted or down-regulated in the majority of the B cell chronic lymphocytic leukemias (B-CLL) (Calin George Adrian et al.; PNAS 2002, 99, 15524-9).

In order to unravel the role of short RNAs in biological processes and, in particular, their implications in diseases, a tool for the detection of short RNAs is needed. Such a tool should ideally allow simultaneous analysis of a variety of short RNAs in a eukaryotic cell. However, due to the short length and the low abundance, the analysis of such RNAs is difficult and time consuming with the tools currently available. The present invention now provides a new tool which is able to detect short RNAs and is thus particularly useful for the elucidation of the roles and functions of short RNAs. As will be apparent to a person of skill in the art in light of this disclosure, the applications of this tool are, however, not limited to the detection and analysis of short RNAs, but can be applied to the detection or analysis of nucleic acids in general.

### SUMMARY OF THE INVENTION

In a first aspect, the present invention provides an oligonucleotide array comprising a surface and a plurality of oligonucleotides, wherein at least one oligonucleotide has at least one modified sugar moiety. In one embodiment, the 2′-OH group of the sugar moiety of said oligonucleotide is substituted. Preferably, said sugar moiety comprises at the 2′- position F; O—, S—, or N-alkyl; O—, S—, or N-alkenyl; O—, S— or N-alkynyl; or O-alkyl-O-alkyl, wherein the alkyl, alkenyl and alkynyl may be substituted or unsubstituted C₁ to C₁₀ alkyl or C₂ to C₁₀ alkenyl and alkynyl, alkoxyalkyl, C₁ to C₁₀ lower alkyl, substituted C₁ to C₁₀ lower alkyl, alkaryl, aralkyl, O-alkaryl or O-aralkyl, SH, SCH₃, Cl, Br, CN, CF₃, OCF₃, SOCH₃, SO₂ CH₃, ONO₂, NO₂, N₃, NH₂, heterocycloalkyl, heterocycloalkaryl, aminoalkylamino, polyalkylamino.

In a preferred embodiment said sugar moiety comprises 2′-MOE, 2′-DMAOE, 2′-methoxy or 2′-aminopropoxy.

In another aspect, the present invention provides a method for the detection of short RNAs comprising the steps of (a) providing a biological sample, wherein said sample comprises short RNAs; (b) contacting said sample with an oligonucleotide array of the present invention; (c) performing a hybridization reaction between the short endogenous RNAs and the oligonucleotides in the array.

In a further aspect, the present invention provides a method to correlate a biological sample to a biological condition comprising (a) providing a biological sample, wherein said sample comprises short RNAs; (b) contacting said sample with an oligonucleotide array of the present invention, wherein said sample comprises a set of predefined sequences suitable for the detection of short RNAs; (c) comparing the hybridization pattern obtained with a standard hybridization pattern.

In another aspect, the present invention provides a method for the prognosis or diagnosis of a disease comprising (a) providing a biological sample, (b) contacting an oligonucleotide array of the present invention corresponding to a set of defined sequences useful for the detection of short RNAs, (c) obtaining a hybridization pattern, (d) comparing said hybridization pattern to a standard hybridization pattern, wherein the presence or absence of a certain pattern is indicative of a likelihood to develop a disease or of the presence of a disease.

### BRIEF DESCRIPTION OF THE DRAWINGS

FIG. 1 Intensity values representing hybridization of seven RNA samples to 1 MM and 2 MM capture probes were normalized to intensities obtained from the individual match sequences. Intensity is defined as Density (mean)—Background (mean). Improved mismatch discrimination with the MOE probes hybridized with Cy5-labelled RNA was obtained by increasing the hybridization temperature from 37° to 42° C. Under the same conditions standard DNA probes with the same length did not reveal any signal intensities.

### DETAILED DESCRIPTION OF THE INVENTION

All patent applications, patents and literature cited herein are hereby incorporated by reference in their entirety.

The present invention provides oligonucleotide micorarrays with high sensitivity and selectivity, which are particularly useful for the detection of short nucleic acid molecules. So far, the detection and analysis of short nucleic acids, such as short RNAs, has proven difficult because of the short length and the low abundance of such nucleic acids. The nucleotide micorarrays which are currently available, are not a suitable tool, because their sensitivity and/or selectivity is too low for the detection of short RNAs. By contrast, the present invention provides oligonucleotide micorarrays which are particularly suitable for the detection of short oligonucleotides and, in particular, of short RNAs.

As used herein, the terms “oligonucleotide” and “oligoribonucleotide” are used interchangeably and mean a polymer composed of ribonucleotide residues or of deoxyribonucleotide residues. Also a polymer composed of both, ribonucleotide and deoxyribonucleotide residues, falls within the meaning of “oligonucleotide” and “oligoribonucleotide” in accordance with the present invention.

The terms “oligonucleotide array” or “array” or “micorarray”, which are interchangeably used hereinbelow, refer to a substrate, preferably a solid substrate, with at least one surface having a plurality of oligonucleotides attached to a rigid surface in different known locations. Oligonucleotide arrays typically have a density of at least 100 oligonucleotides per cm². In certain embodiments the arrays can have a density of about at least 500, at least 1000, at least 10000, at least 10⁵, at least 10⁶, at least 10⁷ oligonucleotides per cm².

In a first aspect, the present invention relates to an oligonucleotide array comprising a surface and a plurality of oligonucleotides, wherein said oligonucleotide array comprises at least one oligonucleotide having at least one modified sugar moiety, hereafter referred as modified oligonucleotides. Preferably, the oligoribonucleotides comprise at least 2, more preferably at least 5 or at least 10 modified sugar moieties. In specific embodiment, all sugar moieties of the oligonucleotides are modified, or, in yet another preferred embodiment, all but 1, 2, 3 or 4 sugar moieties of the oligonucleotides are modified. The oligonucleotide array typically comprises at least 10%, more preferably at least 25%, at least 33%, at least 50%, at least 66%, at least 75%, at least 90% or at least 95% of oligonucleotides comprising modified sugar moieties. In a particularly preferred embodiment, the oligonucleotide array comprises 100% modified oligonucleotides.

The oligonucleotide microarrays of the present invention comprise oligonucleotides with one or more modified sugar moieties. In a preferred embodiment, the sugar moiety is modified on the 2′-OH group of the sugar moiety. A variety of 2′-OH substitutions are known in the art (see modifications in Uhlmann, Eugen. Recent advances in the medicinal chemistry of antisense oligonucleotides. Current Opinion in Drug Discovery & Development (2000), 3(2), 203-213 and Uhlmann, Eugen; Peyman, Anusch. Antisense oligonucleotides: a new therapeutic principle. Chemical Reviews (Washington, DC, United States) (1990), 90(4), 543-84). In another preferred embodiment, the 4′-C of the sugar moiety is not modified, in a more preferred embodiment, the oligonucleotides do not comprise locked nucleic acids (LNA, see for instance (Rajwanshi, Vivek K. et al; The eight stereoisomers of LNA (locked nucleic acid): a remarkable family of strong RNA binding molecules. Angewandte Chemie, International Edition (2000), 39(9), 1656-1659).

Preferred modified sugar moieties, in accordance with the present invention, comprise one of the following at the 2′ position: F; O—, S—, or N-alkyl; O—, S—, or N-alkenyl; O—, S—or N-alkynyl; O—, S—, or N-aryl; or O-alkyl-O-alkyl, wherein the alkyl, alkenyl and alkynyl may be substituted or unsubstituted C₁ to C₁₀ alkyl or C₂ to C₁₀ alkenyl and alkynyl. Other preferred oligonucleotides comprise one or more of the following at the 2′ position of their sugar moieties: lower alkyl, substituted C₁ to C₁₀ lower alkyl, alkaryl, aralkyl, O-alkaryl or O-aralkyl, SH, SCH₃, Cl, Br, CN, CF₃, OCF₃, SOCH₃, SO₂ CH₃, ONO₂, NO₂, N₃, NH₂, heterocycloalkyl, heterocycloalkaryl, aminoalkylamino, polyalkylamino. In another preferred embodiment, the modified sugar moieties do not comprise a 2′-O, 4′-C-methylene linkage. Particularly preferred are sugar moieties substituted with O[(CH2)ₙ O]ₘ CH₃, O(CH₂)ₙ OCH₃, O(CH₂)ₙ NH₂, O(CH₂)ₙ NR₂, O(CH₂)ₙ CH₃, O(CH₂)ₙ ONH₂, and/or O(CH₂)ₙ ON[(CH₂)ₙ CH₃)]₂, where n and m are from 1 to about 10. Another preferred modification includes an alkoxyalkoxy group, in particular 2′-methoxyethoxy (2′—O—CH2 CH2 OCH3, also known as 2′—O—(2-methoxyethyl) or 2′-MOE) (Martin et al., Helv. Chim. Acta, 1995, 78, 486-504). Further preferred modifications includes 2′-dimethylaminooxyethoxy, i.e., a O(CH₂)₂ ON(CH₃)₂ group, also known as 2′-DMAOE, 2′-methoxy (2′—O—CH₃), 2′-aminopropoxy (2′—OCH₂ CH₂ CH₂ NH₂). One of skill in the art may use conventional methods to create such modified sugar structures. Representative United States patents that teach the preparation of such modified sugar structures include, but are not limited to, U.S. Pat. Nos. 4,981,957; 5,118,800; 5,700,920 and 5,969,116 each of which is incorporated by reference herein in its entirety.

It is not necessary for all positions in a given compound to be uniformly modified, and in fact more than one of the aforementioned modifications may be incorporated in a single compound or even at a single nucleoside within an oligonucleotide. The present invention also includes chimeric oligonucleotides. “Chimeric” oligonucleotides in the context of this invention, are oligonucleotides, which contain two or more chemically distinct regions, each made up of at least one monomer unit. Such chimeric oligonucleotides may, for instance, comprise a region of nucleotides with one or more modified sugar moieties as described above and a region of deoxyribonucleotides (Lima, Walt F.; Crooke, Stanley T; Biochemistry (1997), 36(2), 390-398). The oligonucleotides of the present invention may, in addition to the modifications at the 2′ position of the sugar moiety, further comprise other modifications. For instance, the oligonucleotides may have modifications in the backbone. Various backbone modifications are known in the art and such modifications include, for example, phosphorothioates, phosphorodithioates, phosphoramidate and the like (see modifications in Uhlmann, Eugen. Recent advances in the medicinal chemistry of antisense oligonucleotides. Current Opinion in Drug Discovery & Development (2000), 3(2), 203-213 and Uhlmann, Eugen; Peyman, Anusch. Antisense oligonucleotides: a new therapeutic principle. Chemical Reviews (Washington, DC, United States) (1990), 90(4), 543-84).

The oligonucleotides of the oligonucleotide array in accordance with the present invention typically have a length of about 10 to 100 nucleotides. Preferably the length is about 12 to 50 nucleotides, more preferably 15 to 30 nucleotides. In a particularly preferred embodiment, the oligonucleotide length is 18 to 25 nucleotides. Whereas it is not necessary for the oligonucleotides of the oligonucleotide array to have the same length, the oligonucleotide array in accordance with the present invention typically comprises a plurality of oligonucleotides which are of similar or the same length.

Oligonucleotide arrays, also commonly known as “Genechips,” have been described in the art. The oligonucleotide arrays usually comprise a solid substrate with at least one surface on which the oligonucleotides can be attached. The substrate may be formed from inorganic materials such as glass, SiO₂, quartz, Si. Alternatively the substrate can be formed from organic materials such as polymers preferably polycarbonate (PC), poly(methyl methacrylate) (PMMA), polyimide (PI), polystyrene (PS), polyethylene (PE), polyethylene terephthalate (PET) or polyurethane (PU). In one example the substrate is formed from glass. The surface may be composed of the same or different material as the substrate. The substrate and its surface can also be chosen to provide appropriate light- absorbing characteristics. In a preferred embodiment, the substrate and/or the surface is optically transparent. In another preferred embodiment, the substrate comprises an optically transparent layer. The optically transparent layer may be formed from inorganic material. Alternatively it can be formed from organic material. In one example the optically transparent layer is a metal oxide such as Ta₂O₅, TiO₂, Nb₂O₅, ZrO₂, ZnO or HfO₂. The optically transparent layer is non-metallic.

In a particularly preferred embodiment, the oligonucleotide array is placed on an evanescent wave sensor platform as described in WO01/02839. Thus, the sensor platform for use in sample analysis may for instance comprise an optically transparent substrate having a refractive index (n₁), a thin, optically transparent layer, formed on one surface of the substrate, said layer having a refractive index (n₂) which is greater than (n₁), said platform incorporating therein one or multiple corrugated structures comprising periodic grooves which define one or multiple sensing areas or regions, each for one or multiple capture elements, said grooves being so profiled, dimensioned and oriented that either a) coherent light incident on said platform is diffracted into individual beams or diffraction orders which interfere resulting in reduction of the transmitted beam and an abnormal high reflection of the incident light thereby generating an enhanced evanescent field at the surface of the one or multiple sensing areas; or b) coherent and linearly polarized light incident on said platform is diffracted into individual beams or diffraction orders which interfere resulting in almost total extinction of the transmitted beam and an abnormal high reflection of the incident light thereby generating an enhanced evanescent field at the surface of the one or multiple sensing areas.

Oligonucleotide arrays may be formed by chemical in situ oligonucleotide synthesis. In this method, the oligonucleotides are synthesized directly onto the surface of the substrate using, for instance, mechanical synthesis methods or light directed synthesis methods which may incorporate a combination of photolithographic methods and solid phase oligonucleotide synthesis methods such as that described for instance in WO90/033382 or WO92/10092 or very large scale immobilized polymer synthesis (VLSIPS) such as that described in WO98/27430.

Alternatively, oligonucleotides of natural or synthetic origin may be spotted on the chip using various techniques, for instance including inkjet printers which have piezoelectric actuators, electromagnetic actuators, pressure/solenoid valve actuators or other force transducers, bubble jet printers which make use of thermoelectric actuators, laser actuators, ring-pin printers or pin tool-spotters. (Heller M J (2002) Annu Rev Biomed Eng; 4:129-53). The oligonucleotides may be covalently attached to the surface of the substrate. Such covalent attachment typically requires activation of the surface and/or modification of the nucleic acid molecule with a functional/reactive group. The immobilization may also be achieved via a chemical or photochemical linker (WO98/27430 and WO91/16425). Such techniques are known and will be apparent to the person of skill in the art. Reactive or photoreactive groups may be attached to the surface of the platform which may serve as anchor groups for further reaction steps. Alternatively, the oligonucleotides may be attached to the surface by non-covalent binding, such as for instance by electrostatic adsorption onto a positively charged surface film. In a preferred embodiment of the present invention, the oligonucleotides are non-covalently attached to the surface. Functionalized organic molecules can be used which provide hydrocarbon chains to render the platform more hydrophobic, polar groups can be used to render the platform more hydrophilic, or ionic groups, or potentially ionic groups can be used to introduce charges. For instance Polyethyleneglycol (PEG) or derivatives thereof can be used to render the platform hydrophilic, which prevents non-specific absorption of proteins to the platform/surface.

In order to obtain a detectable signal, the nucleic acids of the sample may be labeled. Any label suitable for the detection of oligonucleotides may used. For instance, radioisotopes, chemi-luminescent labels, bio-luminescent or calorimetric labels may be used. In a preferred embodiment luminescent labels are used. Luminescent dyes which may be used include but are not limited to lanthanide complexes (Kricka L J (2002) Stains, labels and detection strategies for nucleic acids assays. Ann Clin Biochem; 39(Pt 2): 114-29) and may be chemically or physically bonded to the oligonucleotide. In a more preferred embodiment, the marker is a fluorescent label. Many suitable fluorophores are known, such as fluorescein, lissamine, phycoerythrin, rhodamine, Cy2, Cy3, Cy3.5, Cy5, Cy5.5, Cy7, FluorX. It will be appreciated that different fluorophores with different spectra may be used in order to distinguish different probes. Alternatively, the oligonucleotides of the oligonucleotide array may be labeled with suitable labels, such as the labels described above.

The nucleic acids of the sample (“probes”) and suitable oligonucleotides of the oligonucleotide array will hybridize, i.e. non-covalent binding of complementary sequences will occur under suitable conditions. Preferably, the sequences are perfectly complementary, but depending on the hybridization conditions, sequences with 1, 2, 3, 4 or 5 mismatches may still hybridize. Suitable hybridization conditions are known in the art or may be determined empirically. Parameters which are well known to affect specificity and kinetics of reaction include salt conditions, ionic composition of the solvent, hybridization temperature, length of oligonucleotide matching sequences, guanine and cytosine (GC) content, presence of hybridization accelerators, pH, specific bases found in the matching sequences, solvent conditions, and addition of organic solvents. For instance, for conditions of high stringency, in order that nucleic acids with only few or no mismatches hybridize, the salt concentration would typically be lower. Ordinary high stringency conditions may utilize a salt concentration of less than about 1 molar, more often less then about 750 millimolar, usually less than about 500 millimolar, and may be as low as about 250 or 150 or 15 millimolar. The typical salt used is sodium chloride (NaCl); however, other ionic salts may be utilized, e.g., KCl, or tetra-alkyl ammonium salts. For lower stringency conditions, depending on the desired stringency hybridization, the salt concentration may be less than about 3 millimolar, preferably less than 2.5 millimolar, less than 2 millimolar, or more preferably less than about 1.5 millimolar. The kinetics of hybridization and the stringency of hybridization also depend upon the temperature at which the hybridization is performed. Temperatures for low stringency hybridization would typically be lower temperatures, for example temperatures from about 15° C. or 20° C. to about 25° C. or 30° C. Where high stringency hybridization is needed, temperatures at which hybridization is performed would typically be high. For example, a temperature of at least 37° C., at least 42° C., at least 48° C., or at least 56° C. may be used. High temperatures, for instance, 80° C. or more may be used for stripping, i.e. disrupting the binding of the complementary sequences. The hybridization reaction may also be followed by a washing step, in which the nucleic acids which did not bind to the oligonucleotides are washed away. However, such a step may also be omitted, for instance when luminescence induced by an evanescent field is detected (WO01/02839).

In a preferred embodiment of the present invention, the hybridization conditions are optimized for the hybridization of modified oligonucleotides, in particular of MOE modified oligonucleotides, with short RNAs. Such optimization may be made empirically and pose no difficulties to the skilled person. The temperature may for instance be from about 30° C. to about 60° C., from about 37° C. to about 60° C. or from about 42° C. to about 56° C.

The detection methods used to determine where hybridization has taken place will depend upon the label selected. Luminescence may be induced by a suitable laser source. Appropriate detectors for luminescence include for instance CCD-cameras, photomultiplier tubes, avalanche photodiodes, hybrid photomultipliers. When fluorescently-labeled probes are used, the detection is preferably by confocal laser microscopy. The signals are recorded and, in a preferred embodiment, analyzed by computer, e.g. by using a 12-bit analog to digital board.

In a second aspect, the present invention provides a method for the detection of short RNAs. As used herein, the term “short RNAs” refers to short RNAs from about 15 to about 30 nucleotides, preferably from about 18 to about 25 nucleotides. The short RNAs include, but are not limited to miRNAs, stRNAs, siRNAs or short hairpin RNAs (shRNAs), or pre-cursors of all of the above. The RNAs may be formed endogenously in the cells, but may also be RNAs that were transfected into the cells, such as for instance siRNAs. The inventors of the present invention have now found that, in accordance with the present invention, short RNAs and, in particular, short endogenous RNAs can be detected by the oligonucleotide arrays of the present invention with a much higher sensitivity and specificity than the presently known methods and tool.

In one embodiment, the present invention provides a method for the detection of short RNAs comprising contacting a biological sample with an oligonucleotide array of the present invention. Biological samples may be derived from cells, tissues, organs, body fluids such as for instance sera, plasma, seminal fluid, urine, synovial fluid and cerebrospinal fluid. The cells or tissue may also be chosen for particular characteristics, for instance, cancerous cells or tissue may be selected or cells or tissue in various developmental stages or in a pathological condition. In a preferred embodiment, the biological sample is derived from a mammalian, more preferably from a rodent, such as for instance from mouse or rat, or, most preferably, from a human being. The nucleic acids of the biological samples may be enriched by a purification step such as for instance phenol/chloroform extraction, ethanol precipitation or gel purification. In a preferred embodiment, the sample is enriched for short RNAs which can for instance be achieved by gel purification or size fractionation. The samples may be used either undiluted or with added solvents. Suitable solvents include water, aqueous buffer solutions or organic solvents. Suitable organic solvents include alcohols, ketones, esters, aliphatic hydrocarbons, aldehydes, acetonitrile or nitrites.

A suitable method for the detection of short RNAs comprises the steps of (a) providing a biological sample, wherein said sample comprises short endogenous RNAs; (b) contacting said sample with an oligonucleotide array in accordance of the present invention; (c) performing a hybridization reaction between the short endogenous RNAs and the oligonucleotides in the array, and, optionally; (d) detecting a hybridization between short RNA of the sample and an oligonucleotide of the array. In a preferred embodiment, the short RNAs of the biological sample are labeled, preferably with a fluorescent dye.

In another embodiment, the methods of the present invention are used for profiling of short RNAs. For instance, oligonucleotide arrays corresponding to a set of defined sequences useful for the detection of short RNAs may be contacted with cell or tissue samples of normal and diseased cells or tissue. The pattern of hybridized oligonucleotides on the array will be indicative of presence of absence of a short RNA in a tissue sample. The patterns of short RNAs present in normal and diseased cells or tissue can thus be compared, thereby enabling to correlate samples to a disease state. Thus, the present invention provides a method to correlate a biological sample or expression levels of a particular short RNA to a health state comprising (a) providing a biological sample, wherein said sample comprises short RNAs; (b) contacting said sample with an oligonucleotide array in accordance with the present invention, wherein said sample comprises a set of predefined sequences suitable for the detection of short RNAs; (c) comparing the hybridization pattern obtained with a standard hybridization pattern. The standard pattern may for instance be obtained from a sample derived from diseased cells or tissue. A similar pattern may thus be indicative of cells or a tissue sample with a certain disease state. In a preferred embodiment, the cell or tissue is infected by a pathogen, such as by human immunodeficiency virus (HIV) infections, influenza infections, malaria, hepatitis, plasmodium, cytomegalovirus, herpes simplex virus, or foot and mouth disease virus. In a preferred embodiment, the cell or tissue is infected by a viral or bacterial pathogen. In another preferred embodiment, the disease is a cancer (see for instance McManus, Michael T. MicroRNAs and cancer. Seminars in Cancer Biology (2003), 13(4), 253-258) and in a more preferred embodiment a solid tumor or a blood malignancy. In a further preferred embodiment, the disease is a neurodegenerative disease such as Parkinson, Alzheimer or Multiple Sclerosis. In a particularly preferred embodiment the disease is fragile X-related mental retardation (see for instance Caudy A A et al. (2002) Genes Dev; 16:2491-6 and Dostie, Josee et al RNA (2003), 9(2), 180-186).

In another preferred embodiment, the oligonucleotide array is comprehensive for the detection of small RNAs of a given organ, tissue or cell of an organism, i.e. the array comprises oligonucleotides for a large part or all of the small RNAs formed in a particular organism or in an organ, tissue or cell of said organism. A large part within this context means at least 60%, preferably at least 80%, more preferably at least 90% or most preferably at least 95% of the small RNAs. The array may also comprise a comprehensive set of predefined sequences of markers of a particular stage or condition of cells, for instance known markers or combination of markers for particular tumors or for a particular type of cell. In another preferred embodiment, the oligonucleotide array is suitable for detecting a specific subset of small RNAs of a given organism, or organ, tissue or cell of said organism, preferably siRNA, more preferably miRNAs or stRNAs.

As will be apparent to a person of skill in the art, the above methods can be used for profiling any biological condition, which has differences in the amount and/or composition of short RNAs and, in particular, of miRNAs in cells or tissue. For instance, a biological sample may be correlated to different stress situations, such as for example hypoxyia or mechanical stress, by such a method using suitable biological samples and appropriate standard patterns, to which the patterns obtained using the biological samples can be compared. Alternatively, biological samples may be correlated to different stages of development.

Another embodiment of the present invention provides a method to explore short RNA and, in particular, miRNA dynamics during differentiation. For example, an oligonucleotide array with a set of defined sequences useful for the detection of short RNAs and, in particular, miRNA may be contacted with biological samples derived for instance from embryonic stem cells undergoing differentiation into different lineages, such as differentiation of hematopoetic cells in vitro, differentiation of myoblasts, or differentiation of PC12 cells into neurons.

Another aspect of the present invention provides methods of prognosing or diagnosing diseases and, in particular, human diseases. Such methods include

(a) providing a biological sample, which may be isolated from a tissue or organ or body fluid of interest and which may be, optionally, previously treated

(b) contacting an oligonucleotide array corresponding to a set of defined sequences useful for the detection of short RNAs, in particular of miRNAs with said sample,

(c) obtaining a hybridization pattern,

(d) comparing said hybridization pattern to a standard hybridization pattern, wherein the presence or absence of a certain pattern is indicative of a likelihood to develop a disease or of the presence of a disease.

For example, a cancerous condition may be indicated by a combination of certain short RNAs. Such a combination will give rise to a specific pattern when such short RNAs are hybridized to an oligonucleotide array with suitable oligonucleotides. Thus, the presence or absence of a certain hybridization pattern of such an oligonucleotide array with a biological sample will be indicative of the presence or absence of a cancerous condition. The pattern may also be compared to a standard pattern obtained with healthy cells, tissues or organs etc. and differences in the pattern obtained from the biological sample as compared to the standard pattern will be indicative of anomalies or disease states in the biological sample analyzed.

The invention is further described, for the purposes of illustration only, in the following examples. Methods of molecular genetics, protein and peptide biochemistry and immunology referred to but not explicitly described in this disclosure and examples are reported in the scientific literature and are well known to those skilled in the art.

### EXAMPLES

### Materials and Methods

### Design and Synthesis of MOE Oligonucleotides

MOE capture probes were designed for 31 human miRNAs identified by Lagos-Quintana M et al.; Science 2001, 294, 853-8, Lagos-Quintana M. et al.; Current Biology, 2002, 12, 735-9, Lagos-Quintana M.; RNA 2003, 9, 175-9, Mourelatos Zissimos et al.; Genes And Development 2002, 16, 720-8. The length of these miRNAs varies from 20 to 24 nucleotides. Also abundance of these miRNAs differs as based on the frequency of cloning individual miRNAs. Since cloning and sequencing procedures employed to identify miRNAs cannot frequently precisely define the 5′ and 3′ extremities of the miRNA, the MOE capture probes were designed to be complementary to 19 nucleotides corresponding to the central portion of the miRNA. For 20 nucleotide long miRNAs, the capture probe is complementary to nineteen 5′-proximal nucleotides of the miRNA, for 21 nucleotide long and longer miRNAs, the capture probes are complementary to nucleotides 2-20 of the miRNA. Maintaining the same (19 nucleotides) length of capture probes should minimize differences in melting temperatures of individual probe-miRNA duplexes.

1 bp and 2 bp mismatch control oligos were designed according to the following permutation rules: A→C; C→A; T→G; G→T. Mismatches were introduced using an algorithm that ensures maximal specificity across all miRNA species (J. Lange, LSI).Synthetic DNA and 2′-MOE modified oligonucleotides described in this invention are prepared using standard phosphoramidite chemistry on ABI394 or Expedite/Moss Synthesizers (Applied Biosystems). Phosphoramidites are dissolved in acetonitrile at 0.05 M concentration. Coupling is made by activation of phosphoramidites by a 0.2 M solution of benzimidazolium triflate in acetonitrile. Coupling times usually comprise between 3 to 6 minutes. A first capping is made using standard capping reagents. Oxidation is made by a 0.5 M solution of t-butyl hydroperoxide in dichloromethane for two minutes. A second capping is performed after oxidation or sulfurization. Oligonucleotide growing chains are detritylated for the next coupling by 2% trichloroacetic acid in dichloromethane. After completion of the sequences the support-bound compounds are cleaved and deprotected as “Trityl-on” by 32% aqueous ammonia at 80° C. for two hours.

The obtained crude solutions are directly purified by RP-HPLC. The purified detritylated compounds are analyzed by Electrospray Mass spectrometry and Capillary Gel Electrophoresis and quantified by UV according to their extinction coefficient at 260 nM. The MOE-oligonucleotides complementary to miRNA sequences (Perfect MATCH=PM) and corresponding 1 (1 MM) and 2 basepair (2 MM) mismatch controls are shown in table 1.

TABLE 1

| No. | miRNA | 1 nt Mismatch (1MM) |
|---|---|---|
| 13249.1 | 1MM_mir-1d | aca tac ttc gtt aca ttc C |
| 13250.1 | 1MM_mir-21 | aac atc agt atg ata agc T |
| 13251.1 | 1MM_mir-22 | agt tct tca cct ggc agc T |
| 13252.1 | 1MM_mir-16 | cca ata ttt ccg tgc tgc T |
| 13253.1 | 1MM_let7a | cta tac aac ata cta cct C |
| 13254.1 | 1MM_let7b | cca cac aac ata cta cct C |
| 13255.1 | 1MM_mir-19b | gtt ttg cat tga ttt gca C |
| 13256.1 | 1MM_mir-23 | gaa atc cct tgc aat gtg A |
| 13257.1 | 1MM_mir-20 | cct gca cta gaa gca ctt T |
| 13258.1 | 1MM_mir-24 | gtt cct gct taa ctg agc C |
| 13259.1 | 1MM_mir-96 | aaa aat gtg ata gtg cca A |
| 13260.1 | 1MM_mir-122a | aac acc att ttc aca ctc C |
| 13261.1 | 1MM_mir-124a | gca ttc acc tcg tgc ctt A |
| 13262.1 | 1MM_mir-91 | cct gca ctg gaa gca ctt T |
| 13263.1 | 1MM_mir-97 | tcc agt cga tga tgt tta C |
| 13264.1 | 1MM_mir-24 | gtt cct gct taa ctg agc C |
| 13265.1 | 1MM_mir-102 | ctg att tca cat ggt gct A |
| 13266.1 | 1MM_mir-104 | gct tat cag cct gat gtt G |
| 13267.1 | 1MM_mir-93 | acc tgc acg cag agc act T |
| 13268.1 | 1MM_mir-95 | ctc aat aaa gac ccg ttg A |
| 13269.1 | 1MM_mir-98 | caa tac aac gta cta cct C |
| 13270.1 | 1MM_mir-99 | caa gat cgg ctc tac ggg T |
| 13271.1 | 1MM_mir-100 | caa gtt cgg ctc tac ggg T |
| 13272.1 | 1MM_mir-18 | tct gca cta tat gca cct T |
| 13273.1 | 1MM_mir-92 | agg ccg gga aaa gtg caa T |
| 13274.1 | 1MM_mir-94 | tct gca ctg gca gca ctt T |
| 13275.1 | 1MM_mir-27 | cgg aac tta tcc act gtg A |
| 13276.1 | 1MM_mir-101 | tca gtt atc cca gta ctg T |
| 13277.1 | 1MM_mir-25 | aga ccg aga aaa gtg caa T |
| 13278.1 | 1MM_mir-26a | cct atc ctg tat tac ttg A |
| 13279.1 | 1MM_mir-28 | caa tag act ttg agc tcc T |
| No. | miRNA | 2 nt mismatch (2MM) |
| 13280.1 | 2MM_mir-1d | aca tac tta gtt aca ttc C |
| 13281.1 | 2MM_mir-21 | aac atc agg atg ata agc T |
| 13282.1 | 2MM_mir-22 | agt tct tcc cct ggc agc T |
| 13283.1 | 2MM_mir-16 | cca ata ttg ccg tgc tgc T |
| 13284.1 | 2MM_let7a | cta tac aaa ata cta cct C |
| 13285.1 | 2MM_let7b | cca cac aaa ata cta cct C |
| 13286.1 | 2MM_mir-19b | gtt ttg cag tga ttt gca C |
| 13287.1 | 2MM_mir-23 | gaa atc ccg tgc aat gtg A |
| 13288.1 | 2MM_mir-20 | cct gca ctc gaa gca ctt T |
| 13289.1 | 2MM_mir-24 | gtt cct gcg taa ctg agc C |
| 13290.1 | 2MM_mir-96 | aaa aat gtt ata gtg cca A |
| 13291.1 | 2MM_mir-122a | aac acc atg ttc aca ctc C |
| 13292.1 | 2MM_mir-124a | gca ttc aca tcg tgc ctt A |
| 13293.1 | 2MM_mir-91 | cct gca ctt gaa gca ctt T |
| 13294.1 | 2MM_mir-97 | tcc agt cgc tga tgt tta C |
| 13295.1 | 2MM_mir-24 | gtt cct gcg taa ctg agc C |
| 13296.1 | 2MM_mir-102 | ctg att tcc cat ggt gct A |
| 13297.1 | 2MM_mir-104 | gct tat cat cct gat gtt G |
| 13298.1 | 2MM_mir-93 | acc tgc act cag agc act T |
| 13300.1 | 2MM_mir-98 | caa tac aaa gta cta cct C |
| 13301.1 | 2MM_mir-99 | caa gat cgt ctc tac ggg T |
| 13302.1 | 2MM_mir-100 | caa gtt cgt ctc tac ggg T |
| 13303.1 | 2MM_mir-18 | tct gca ctc tat gca cct T |
| 13304.1 | 2MM_mir-92 | agg ccg ggc aaa gtg caa T |
| 13305.1 | 2MM_mir-94 | tct gca ctt gca gca ctt T |
| 13306.1 | 2MM_mir-27 | cgg aac ttc tcc act gtg A |
| 13307.1 | 2MM_mir-101 | tca gtt ata cca gta ctg T |
| 13308.1 | 2MM_mir-25 | aga ccg agc aaa gtg caa T |
| 13309.1 | 2MM_mir-26a | cct atc ctt tat tac ttg A |
| 13310.1 | 2MM_mir-28 | caa tag acg ttg agc tcc T |

n(g,a,t)=2′-O-(2-methoxyethyl)-ribonucleoside, c=2′-O-(2-methoxyethyl)-5-methyl cytidine. Capital letters at the 3′-end indicate N(A, G, C, T) 2′-deoxynucleotides (nts). For practical reasons, all sequences were synthesized employing DNA supports leading to MOE oligonucleotides with one 2′-deoxynucleotide at the 3′-terminal position.

### Printing and Hybridisation of Oligonucleotide Microarrays

NovaChips (D, Budach W, Wanke C, Chibout S D (2003) Evanescent resonator chips: a universal plafform with superior sensitivity for fluorescence-based microarrays. Biosens Bioelectron; 18:489-97) were prepared, printed, and hybridized essentially as described. Hybridization mixtures contained 3 microgram of labeled microRNA (Budach, Wolfgang; Neuschaefer, Dieter; Wanke, Christoph; Chibout, Salah-Dine. Generation of transducers for fluorescence-based microarrays with enhanced sensitivity and their application for gene expression profiling. Analytical Chemistry (2003), 75(11), 2571-2577).

### Preparation of miRNAs from Human HeLa and Mouse P19 Cells.

HeLa cells were grown at 37° C. in Dulbecco's modified Eagle's medium supplemented with 10% FCS and 2 mM L-Glutamin. Approximatively 1,5×10⁷ cells were washed with PBS and RNA was extracted with 1 ml Trizol®) (Life-Technologies™) per 10 cm² surface according the manufacturer protocol. The DNA present in the aqueous phase was digested with 20 U DNase I per 500 μl for 1 hr at 37° C. Following phenol/chloroform extraction, total RNA was ethanol precipitated, resuspended in RNase-free water and 100 μg of RNA was applied to a RNeasy® mini spin column (Qiagen) following the RNA cleanup protocol of the manufacturer. The RNAs species smaller than ˜200 nts contained in the flow through were ethanol-precipitated, resuspended in the denaturing gel loading buffer (70% formamide, 30 mM EDTA, 0.05% Xylene Cyanol, 0.05% Bromophenol Blue) and separated on a 8 M urea-12.5% polyacrylamide gel run in TBE buffer. RNAs ranging in size from 15 to 30 nts were excised from the gel under UV light shadowing, eluted for 16 hr at 4° C. with a solution containing 500 mM ammonium acetate, 1 mM EDTA, and 20% phenol/chloroform, ethanol precipitated and resuspended in RNase-free water. The amount of recovered RNA was estimated by measuring optical density at 260 nm. Alternatively, RNA samples were applied to a RNeasy® mini spin column (Qiagen) and used in chip experiments omitting the PAGE purification step.

### Fluorescent Labeling of Synthetic Control miRNA Oligos and Fractionated Size-Selected miRNAs from HeLa and P19 Cells

19-mer RNA oligonucleotides complementary to eight different miRNA sequences were purchased from Xeragon. For labeling of the RNAs, 9 μg RNA in 9 μl water was oxidized into dialdehyde by adding 1 μl freshly prepared 100 mM aqueous sodium periodate followed by an 1 h incubation at room temperature in the dark. The excess of oxidant was removed by adding 1 μl of a 200 mM solution of sodium sulfite and incubation for 20 min at room temperature. After adding 12 μl of 50 mM sodium acetate buffer pH 4, 5 μl of 20 mM aqueous ethylenediamine hydrochloride pH 7.2 was added to the oxidized RNA. The reaction mixture was incubated for 1 hr at 37° C., and the aldimine bond between the RNA and the spacer was stabilized by reduction with 2 μl freshly prepared 200 mM sodium cyanoborhydride in acetonitrile. Incubation took place for 30 min. at room temperature and precipitation was done with 2 volumes of 2% lithium perchlorate in acetone for 1 hour at 0° C. The sample was spun at 14000 rpm for 45 min (3-4° C.) and after removing of the supernant the RNA pellet was washed twice with acetone and air dried. Conjugation was carried out by resuspending the amino modified RNA in 5 μl DEPC-treated water and adding 5 μl of 30 mM Cy5 N-hydroxysuccinimidyl active ester in 1 M sodium phosphate buffer (pH 7.8). After incubation for 1 hr at room temperature in the dark the RNA was precipitated with 2.5 volumes of 100% ice-cold ethanol for 1 h at −20° C. The sample was spun at 14000 rpm for 30 min (3-4° C.) and after removing of the supernant the Cy5-RNA pellet was washed twice with ice-cold 70% aqueous ethanol and air dried. The quality and amount of labeled RNA was analysed by Capillary Gel Electrophoresis and quantified by UV according to the extinction coefficient at 260 nm.

Cy5-labelled RNA sequences are contained in table 2.

TABLE 2
Sequences of 3′-Cy5 labeled synthetic miRNA equivalents used for hybridization to
the immobilized complementary “capture” oligonucleotides. Base-pairing nucleotides are
highlighted in bold.

| Nr | miRNA | Compl | Sequence | Capt Seq on a chip | Origin | Acc Nr. |
|---|---|---|---|---|---|---|
| 3839 | mir-21 | match | UAGCUUAUCAGACUGAUGUUGAC | aacatcagtctgataagcT | Human | AF480524 |
| | | 1 MM | | aacatcagtatgataagcT | | |
| | | 2 MM | | aacatcaggatgataagcT | | |
| 3840 | mir-23 | match | AUCACAUUGCCAGGGAUUUCCA | gaaatccctggcaatgtgA | Human | AF480526 |
| | | 1 MM | | gaaatcccttgcaatgtgA | | |
| | | 2 MM | | gaaatcccgtgcaatgtgA | | |
| 3841 | mir-124a | match | UUAAGGCACGCGGUGAAUGCCA | gcattcaccgcgtgccttA | Mouse | AJ459733 |
| | | 1 MM | | gcattcacctcgtgccttA | | |
| | | 2 MM | | gcattcacatcgtgccttA | | |
| 3842 | mir-24 | match | UGGCUCAGUUCAGCAGGAACAG | gttcctgctgaactgagcC | Human | AF480527 |
| | | 1 MM | | gttcctgcttaactgagcC | | |
| | | 2 MM | | gttcctgcgtaactgagcC | | |
| 3843 | mir-99 | match | AACCCGUAGAUCCGAUCUUGUG | caagatcggatctacgggT | Human | AF480537 |
| | | 1 MM | | caagatcggctctacgggT | | |
| | | 2 MM | | caagatcgtctctacgggT | | |
| 3844 | mir-100 | match | AACCCGUAGAUCCGAACUUGUG | caagttcggatctacgggT | Human | AF480498 |
| | | 1 MM | | caagttcggctctacgggT | | |
| | | 2 MM | | caagttcgtctctacgggT | | |
| 11657 | mir-30a-s/ | match | GUAAACAUCCUCGACUGGA | tccagtcgaggatgtttaC | Human | |
| | mir-97 | 1 MM | | tccagtcgatgatgtttaC | | |
| | | 2 MM | | tccagtcgctgatgtttaC | | |
| 11660 | mir-104 | match | CAACAUCAGUCUGAUAAGC | gcttatcagactgatgttG | Human | |
| | | 1 MM | | gcttatcagcctgatgttG | | |
| | | 2 MM | | gcttatcatcctgatgttG | | |

### Results

The affinity and specificity of the oligonucleotide capture probes were examined using a chip containing a panel of spotted MOE and DNA oligonucleotides together with their corresponding 1 and 2 nucleotide mismatch controls. RNA oligonucleotides complementary to eight different miRNA sequences represented on the chip were labeled with Cy5 (Table. 2) and hybridized with the chip at different conditions.

A common problem for all DNA oligonucleotide microarrays is the need for an adequate compromise with respect to the sensitivity and specificity of the platform.

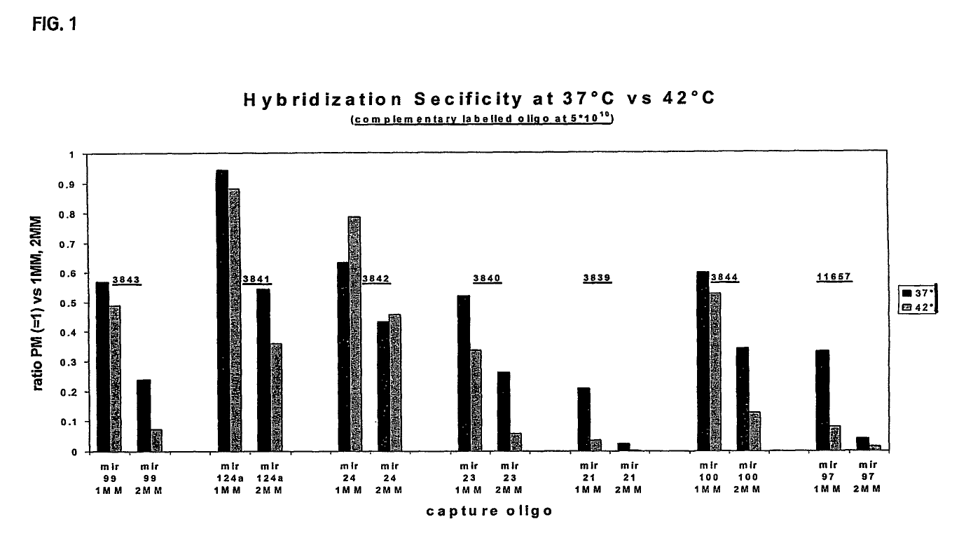

As demonstrated in FIG. 1, the fluorescence intensities obtained with the MOE-modified 1 and 2 nucleotide mismatch oligonucleotides show a significant intensity decrease relative to the perfectly matched duplexes. Increasing the hybridization temperature should further improve the discrimination. In contrast, the corresponding standard DNA capture probes are not capable of forming stable duplexes under the chosen hybridization stringency conditions, resulting in no significant intensity values from all DNA capture probes.

In 5 out of 8 cases mismatch discrimination with the MOE probes could be significantly improved by increasing the hybridization temperature from 37 to 42° C. (FIG. 1), without compromising their capture sensitivity. In the case of oligonucleotide mir-99 and mir-100, which represent miRNAs that differ by only a single nucleotide, a significant degree of cross reactivity was observed.

### Hybridization of miRNAs from Human and Mouse Cell Extracts to MOE NovaChips

In a next step, size-selected miRNAs were extracted from HeLa/P19 mouse cells, labeled with Cy5 and hybridized with probes to a chip of high sensitivity (Novachip: Generation of transducers for fluorescence-based microarrays with enhanced sensitivity and their application for gene expression profiling. Budach, Wolfgang; Neuschaefer, Dieter; Wanke, Christoph; Chibout, Salah-Dine. Novartis Pharma A G Switzerland, Basel, Switz. Analytical/Chemistry (2003), 75(11), 2571-2577) at temperatures ranging from 30° C. to 56° C. The fluorescence intensities measured for 31 different labeled miRNAs having a complementary MOE capture probe, a 1 nt MM and a 2 nt MM control on the Chip are shown in Table 3. Even though specific hybridization of some miRNAs could already be observed at 30° C. and 37° C. (as based on comparison of signals obtained with wild-type, and 1 MM and 2 MM MOE probes), the discrimination between mismatched and fully-complementary sequences present on the NovaChip was better at 42° C. or higher temperatures. Performing hybridization at 48° C. and 56° C. allowed a specific detection of almost all miRNAs, with a concomitant decrease in intensity at higher temperatures. In few cases no signal could be recorded at 56° C. By performing hybridization at three different temperatures (42, 48 and 56° C.), it was possible to record specific signals for nearly all tested miRNAs. Indeed, for only six miRNAs the signal appeared to be either absent or non-specific at any temperature tested. This could be due to the absence of a specific miRNA in the cell isolate or due to the presence of a cross-hybridizing unrelated RNA in RNA samples used for hybridization, respectively. As exemplified by one case, if a single mismatch did not allow for a specific detection of the miRNA, two mismatches allowed for a better discrimination. Finally, the intensity values from two individually-conducted hybridizations at 42° C. (data not shown) revealed comparable intensity values indicating a high level of reproducibility.

TABLE 3
HeLa mIRNA labeled with Cy5 was hybridized
at different temperatures (T) under the de-
described conditions on the chip. A hybridi-
zation temperature of 48° C. (marked in bold)
appears to be the best compromise between signal
intensity and specificity for most probes on the
chip.

| | | |
|---|---|---|
| | | 48° C. |
| | | Density |
| | | (mean)- |
| | hybridization temp. | Background |
| Probe Name | Sequence | (mean) |

| | | |
|---|---|---|
| let7a | cta tac aac cta cta cct C | 3306 |
| 1MM_let7a | cta tac aac ata cta cct C | −35 |
| 2MM_let7a | cta tac aaa ata cta cct C | −46 |
| let7b | cca cac aac cta cta cct C | 2436 |
| 1MM_let7b | cca cac aac ata cta cct C | −7 |
| 2MM_let7b | cca cac aaa ata cta cct C | −81 |
| mir-100 | caa gtt cgg atc tac ggg T | 2459 |
| 1MM_mir-100 | caa gtt cgg ctc tac ggg T | 1056 |
| 2MM_mir-100 | caa gtt cgt ctc tac ggg T | 24 |
| mir-101 | tca gtt atc aca gta ctg T | 64 |
| 1MM_mir-101 | tca gtt atc cca gta ctg T | 0 |
| 2MM_mir-101 | tca gtt ata cca gta ctg T | −43 |
| mir-102 | ctg att tca aat ggt gct A | 624 |
| 1MM_mir-102 | ctg att tca cat ggt gct A | 6 |
| 2MM_mir-102 | ctg att tcc cat ggt gct A | 130 |
| mir-104 | gct tat cag act gat gtt G | −44 |
| 1MM_mir-104 | gct tat cag cct gat gtt G | 6 |
| 2MM_mir-104 | gct tat cat cct gat gtt G | −17 |
| mir-122a | aac acc att gtc aca ctc C | −4 |
| 1MM_mir-122a | aac acc att ttc aca ctc C | −54 |
| 2MM_mir-122a | aac acc atg ttc aca ctc C | −21 |
| mir-124a | gca ttc acc gcg tgc ctt A | 554 |
| 1MM_mir-124a | gca ttc acc tcg tgc ctt A | 541 |
| 2MM_mir-124a | gca ttc aca tcg tgc ctt A | −35 |
| mir-16 | cca ata ttt acg tgc tgc T | 1031 |
| 1MM_mir-16 | cca ata ttt ccg tgc tgc T | 86 |
| 2MM_mir-16 | cca ata ttg ccg tgc tgc T | 173 |
| mir-18 | tct gca cta gat gca cct T | 1013 |
| 1MM_mir-18 | tct gca cta tat gca cct T | 242 |
| 2MM_mir-18 | tct gca ctc tat gca cct T | 13 |
| mir-19b | gtt ttg cat gga ttt gca C | 7243 |
| 1MM_mir-19b | gtt ttg cat tga ttt gca C | 15 |
| 2MM_mir-19b | gtt ttg cag tga ttt gca C | −12 |
| mir-1d | aca tac ttc ttt aca ttc C | −9 |
| 1MM_mir-1d | aca tac ttc gtt aca ttc C | 96 |
| 2MM_mir-1d | aca tac tta gtt aca ttc C | −79 |
| mir-20 | cct gca cta taa gca ctt T | 2531 |
| 1MM_mir-20 | cct gca ctc gaa gca ctt T | 8 |
| 2MM_mir-20 | cct gca ctc gaa gca ctt T | 13 |
| mir-21 | aac atc agt ctg ata agc T | 2796 |
| 1MM_mir-21 | aac atc agt atg ata agc T | −9 |
| 2MM_mir-21 | aac atc agg atg ata agc T | 37 |
| mir-22 | agt tct tca act ggc agc T | 1820 |
| 1MM_mir-22 | agt tct tca cct ggc agc T | 1183 |
| 2MM_mir-22 | agt tct tcc cct ggc agc T | 2771 |
| mir-23 | gaa atc cct ggc aat gtg A | 9291 |
| 1MM_mir-23 | gaa atc cct tgc aat gtg A | 102 |
| 2MM_mir-23 | gaa atc ccg tgc aat gtg A | 16 |
| mir-24 | gtt cct gct gaa ctg agc C | 5708 |
| 1MM_mir-24 | gtt cct gct taa ctg agc C | 4022 |
| 2MM_mir-24 | gtt cct gcg taa ctg agc C | 1305 |
| mir-24 | gtt cct gct gaa ctg agc C | 6171 |
| 1MM_mir-24 | gtt cct gct taa ctg agc C | 3858 |
| 2MM_mir-24 | gtt cct gcg taa ctg agc C | 1282 |
| mir-25 | aga ccg aga caa gtg caa T | 1186 |
| 1MM_mir-25 | aga ccg aga aaa gtg caa T | −37 |
| 2MM_mir-25 | aga ccg agc aaa gtg caa T | −36 |
| mir-26a | cct atc ctg gat tac ttg A | 1533 |
| 1MM_mir-26a | cct atc ctg tat tac ttg A | 97 |
| 2MM_mir-26a | cct atc ctt tat tac ttg A | −66 |
| mir-27 | cgg aac tta gcc act gtg A | 29330 |
| 1MM_mir-27 | cgg aac tta tcc act gtg A | 996 |
| 2MM_mir-27 | cgg aac ttc tcc act gtg A | 1064 |
| mir-28 | caa tag act gtg agc tcc T | 836 |
| 1MM_mir-28 | caa tsg act ttg agc tcc T | −17 |
| 2MM_mir-28 | caa tag acg ttg agc tcc T | ∓36 |
| mir-91 | cct gca ctg taa gca ctt T | 4435 |
| 1MM_mir-91 | cct gca ctg gaa gca ctt T | 297 |
| 2MM_mir-91 | cct gca ctt gaa gca ctt T | −42 |
| mir-92 | agg ccg gga cas gtg caa T | 5896 |
| 1MM_mir-92 | agg ccg gga aaa gtg caa T | 3043 |
| 2MM_mir-92 | agg ccg ggc aaa gtg caa T | 7643 |
| mir-93 | acc tgc acg aag agc act T | 319 |
| 1MM_mir-93 | acc tgc acg cag agc act T | 19 |
| 2MM_mir-93 | acc tgc act cag agc act T | 56 |
| mir-94 | tct gca ctg tca gca ctt T | 2340 |
| 1MM_mir-94 | tct gca ctg gca gca ctt T | 197 |
| 2MM_mir-94 | tct gca ctt gca gca ctt T | 717 |
| mir-95 | ctc aat aaa tac ccg ttg A | −42 |
| 1MM_mir-95 | ctc aat aaa gac ccg ttg A | −40 |
| 2MM_mir-95 | ctc aat aac gac ccg ttg A | −7 |
| mir-96 | aaa aat gtg cta gtg cca A | 225 |
| 1MM_mir-96 | aaa aat gtg ata gtg cca A | −46 |
| 2MM_mir-96 | aaa aat gtt ata gtg cca A | −63 |
| mir-97 | tcc agt cga gga tgt tta C | 4811 |
| 1MM_mir-97 | tcc agt cga tga tgt tta C | 39 |
| 2MM_mir-97 | tcc agt cgc tga tgt tta C | 12 |
| mir-98 | caa tac aac tta cta cct C | 82 |
| 1MM_mir-98 | caa tac aac gta cta cct C | −30 |
| 2MM_mir-98 | caa tac aaa gta cta cct C | −33 |
| mir-99 | caa gat cgg atc tac ggg T | 2140 |
| 1MM_mir-99 | caa gat cgg ctc tac ggg T | 1059 |
| 2MM_mir-99 | caa gat cgt ctc tac ggg T | 127 |

1. An oligonucleotide array comprising a surface and a plurality of oligonucleotides, wherein at least one oligonucleotide has at least one modified sugar moiety.

2. An oligonucleotide array according to claim 1, wherein the 2′-OH group of the sugar moiety is substituted.

3. An oligonucleotide array according to claim 2, wherein the sugar moiety comprises at the 2′- position: F; O—, S—, or N-alkyl; O—, S—, or N-alkenyl; O—, S—or N-alkynyl; or O-alkyl-O-alkyl, wherein the alkyl, alkenyl and alkynyl may be substituted or unsubstituted C₁ to C₁₀ alkyl or C₂ to C₁₀ alkenyl and alkynyl, alkoxyalkyl, C₁ to C₁₀ lower alkyl, substituted C₁ to C₁₀ lower alkyl, alkaryl, aralkyl, O-alkaryl or O-aralkyl, SH, SCH₃, Cl, Br, CN, CF₃, OCF₃, SOCH₃, SO₂ CH₃, ONO₂, NO₂, N₃, NH₂, heterocycloalkyl, heterocycloalkaryl, aminoalkylamino, polyalkylamino.

4. An oligonucleotide array according to any of the previous claims wherein the sugar moiety comprises a 2′-MOE, 2′-DMAOE, 2′-methoxy or 2′-aminopropoxy.

5. An oligonucleotide array according to any of the previous claims, wherein said oligonucleotides have a length of about 15 to 50 nucleotides.

6. An oligonucleotide array according to any of the previous claims, wherein said oligonucleotides comprise at least 10 modified sugar moieties.

7. An oligonucleotide array according to any of the previous claims, wherein said oligonucleotide array comprise at least 50% oligonucleotides with modified sugar moieties.

8. An oligonucleotide array according to any of the previous claims wherein said oligonucleotide array comprises oligonucleotides which specifically hybridize to short mammalian RNAs.

9. The oligonucleotide array of claim 8, wherein said oligonucleotides specifically hybridize to short human RNAs.

10. An oligonucleotide array according to any of the previous claims wherein said oligonucleotide array is comprehensive for the detection of small RNAs of a given organ, tissue or cell of an organism.

11. An oligonucleotide array according to any of the previous claims, wherein said oligonucleotides are noncovalently attached to the surface.

12. An oligonucleotide array according to any of the previous claims, wherein said oligonucleotide array comprises oligonucleotides with one or more deoxyribonucleotides.

13. An oligonucleotide array according to any of the previous claims, wherein the oligonucleotide array can be used on an evanescent wave sensor platform.

14. A method for the detection of short RNAs comprising the steps of (a) providing a biological sample, wherein said sample comprises short RNAs; (b) contacting said sample with an oligonucleotide array according to any claim 1; (c) performing a hybridization reaction between the short endogenous RNAs and the oligonucleotides in the array.

15. A method to correlate a biological sample to a biological condition comprising (a) providing a biological sample, wherein said sample comprises short RNAs; (b) contacting said sample with an oligonucleotide array according claim 1, wherein said array comprises a set of predefined sequences suitable for the detection of short RNAs; (c) comparing the hybridization pattern obtained with a standard hybridization pattern.

16. A method according to claim 14, wherein said short RNAs are micro RNAs (miRNAs).

17. A method according to claim 15 wherein the biological sample is correlated to a health state.

18. A method for the prognosis or diagnosis of a diseases comprising (a) providing a biological sample, (b) contacting an oligonucleotide array according to claim 1 corresponding to a set of defined sequences useful for the detection of short RNAs, (c) obtaining a hybridization pattern, (d) comparing said hybridization pattern to a standard hybridization pattern, wherein the presence or absence of a certain pattern is indicative of a likelihood to develop a disease or of the presence of a disease.

19. A method according to claim 18, wherein the biological sample is from a human.

20. A method according to claim 18, wherein the disease is cancer, a neurodegenerative disease or an infectious disease.
